(19) United States
(12) Patent Application Publication
(10) Pub. No.: US 2008/0265453 A1
(43) Pub. Date: Oct. 30, 2008

(54) Tire Repair Tools And Method

(76) Inventor: Russell J. Brazeau, Menomonee Falls, WI (US)

Correspondence Address: DONALD J. ERSLER, S.C., 725 GARVENS AVENUE, BROOKFIELD, WI, 53005, US

(21) Appl. No.: 11/739,794

(22) Filed: Apr. 25, 2007

(51) Int. Cl. B29C 73/00

(52) U.S. Cl. 264/36.14

(57) ABSTRACT

The tire repair tools and method preferably includes a rasp tool, an insertion tool and a power tool. The rasp tool preferably includes a modified drill bit and a quick release end. The quick release end is preferably inserted into a quick chuck. The insertion tool preferably includes a plug retention end, a shank and the quick release end. A plug slot is disposed in the plug retention end. A sealing plug is inserted into the plug slot, similar to a prior art tire repair tool. In a second embodiment, the quick release ends are replaced with a socket end. In a third embodiment, the quick release ends are replaced with a T-handle. The rasp tool cleans out a tire hole and the insertion tool is used to inserted the sealing plug with a drill, ratchet or T-handle.

### BACKGROUND OF THE INVENTION

1. Field of the Invention

The present invention relates generally to tire repair with plugs and more specifically to tire repair tools and method, which require less physical strength to fix a puncture than that of the prior art.

2. Discussion of the Prior Art

There are numerous tire repair devices that use rubber coated plugs to seal a hole in a tubeless tire. U.S. Pat. No. 3,783,715 to Niconchuk discloses tire repair tools. The Niconchuk patent includes a tire repair tool for inserting plugging material typically in the form of rubber coated twisted strands, into a tire puncture. The plugging material is threaded into the open eye of a needle forming a part of the tool and inserted into the puncture. The inserting motion is limited by a stop free to rotate on the needle's shank so that the ends of the strand are not drawn into the puncture. U.S. Pat. No. 3,785,896 to Kassel discloses a tire puncture repair system. The Kassel patent includes an implement for forming a repair plug and inserting the same into a tire casing to seal a puncture wound. The implement includes an insertion needle having a hook adjacent its free end and a gaff retractable away from the needle. However, both these tools require great physical strength to insert a sealing plug into the puncture in a tire.

Accordingly, there is a clearly felt need in the art for tire repair tools and method, which do not require great physical strength to insert a sealing plug into a tire; allows the sealing plug to be released from an insertion tool with minimal stress to the sealing plug; and includes a stop to prevent over insertion of the tire repair tools.

### SUMMARY OF THE INVENTION

The present invention provides tire repair tools and method, which require less physical strength to fix a puncture than that of the prior art. The tire repair tools and method preferably includes a rasp tool, an insertion tool and a power tool. The rasp tool preferably includes a modified drill bit and a quick release end. A plurality of rasp notches are formed on the flutes of the modified drill bit to simulate the function of a rasp tool. An elongated point is formed on one end of the drill bit and the quick release end is formed on the other end thereof. The quick release end is preferably inserted into a quick chuck. The quick chuck is retained in a chuck of a power tool, such as a drill. A perimeter of the modified drill bit is less than the perimeter of the quick release end, such that thereof acts as a stop.

The insertion tool preferably includes a plug retention end, a shank and the quick release end. The plug retention end is formed on one end of the shank and the quick release end is formed on the other end thereof. A perimeter of the shank is less than a perimeter of the quick release end, such that thereof acts as a stop. The plug retention end includes a first projection, a second projection and a plug slot. The plug slot is disposed between the first projection and the second projection.

A sealing plug is inserted into the plug slot with minimum amount of effort. The first projection is preferably formed by gradually curving one end thereof, such that the center of the point substantially falls on a centerline of the shank. An end of the second projection preferably has a length that is less than that of the first projection. The quick release end is inserted into a quick chuck. The quick chuck is retained in the chuck of the power tool. However, quick release ends of the rasp and the insertion tools may also be directly inserted into a chuck of a drill.

In a second embodiment, the quick release ends of the rasp and insertion tools are replaced with a socket end. The socket end is sized to receive a ratchet projection. In a third embodiment, the quick release ends of the rasp and insertion tools are replaced with a T-handle.

The method of repairing a tire includes inserting the rasp tool into a tire hole and stroking the rasp tool in the tire hole several times to produce a clean hole, while rotating in a drill. Next, the sealing plug is inserted into the plug slot and coated with glue. The insertion tool is then inserted into the tire hole and the drill actuated intermittently, until the insertion tool is fully inserted into the hole. Finally, the insertion tool is then withdrawn from the hole. The steps used for repairing a tire in the second and third embodiments are similar to that of the first embodiment.

Accordingly, it is an object of the present invention to provide tire repair tools and method, which do not require great physical strength to insert a sealing plug into a tire.

It is further object of the present invention to provide tire repair tools and method, which allow the sealing plug to be released from the insertion tool with minimal stress to the sealing plug.

Finally, it is another object of the present invention to provide tire repair tools and method, which include a stop to prevent over insertion of the tire repair tools.

These and additional objects, advantages, features and benefits of the present invention will become apparent from the following specification.

### BRIEF DESCRIPTION OF THE DRAWINGS

FIG. 1 is a side view of a insertion tool retained in a quick chuck and the quick chuck retained in a chuck of a power drill of tire repair tools and method in accordance with the present invention.

FIG. 2 is a side view of a rasp tool of tire repair tools and method in accordance with the present invention.

FIG. 3 is a side view of an insertion tool of tire repair tools and method in accordance with the present invention.

FIG. 4 is a side view of an insertion tool of tire repair tools and method rotated 90 degrees from that of FIG. 3 in accordance with the present invention.

FIG. 4a is an enlarged side view of a plug retention end of an insertion tool of tire repair tools and method rotated 90 degrees from that of FIG. 3 in accordance with the present invention.

FIG. 5 is a front end view of an insertion tool of the tire repair tools and method in accordance with the present invention.

FIG. 6 is a side view of a rasp tool fully inserted into a tire puncture of the tire repair tools and method in accordance with the present invention.

FIG. 7 is a side view of an insertion tool retaining a sealing plug above a tire puncture of a tire repair tool and method in accordance with the present invention.

FIG. 8 is a side view of an insertion tool retaining a sealing plug, fully inserted into a tire puncture of a tire repair tool and method in accordance with the present invention.

FIG. 9 is a cross sectional side view of a sealing plug retained in a tire puncture of a tire repair tool and method in accordance with the present invention.

FIG. 10 is a side view of a second embodiment of an insertion tool retained in a ratchet of tire repair tools and method in accordance with the present invention.

FIG. 11 is a side view of a third embodiment of an insertion tool of tire repair tools and method in accordance with the present invention.

### DETAILED DESCRIPTION OF THE PREFERRED EMBODIMENTS

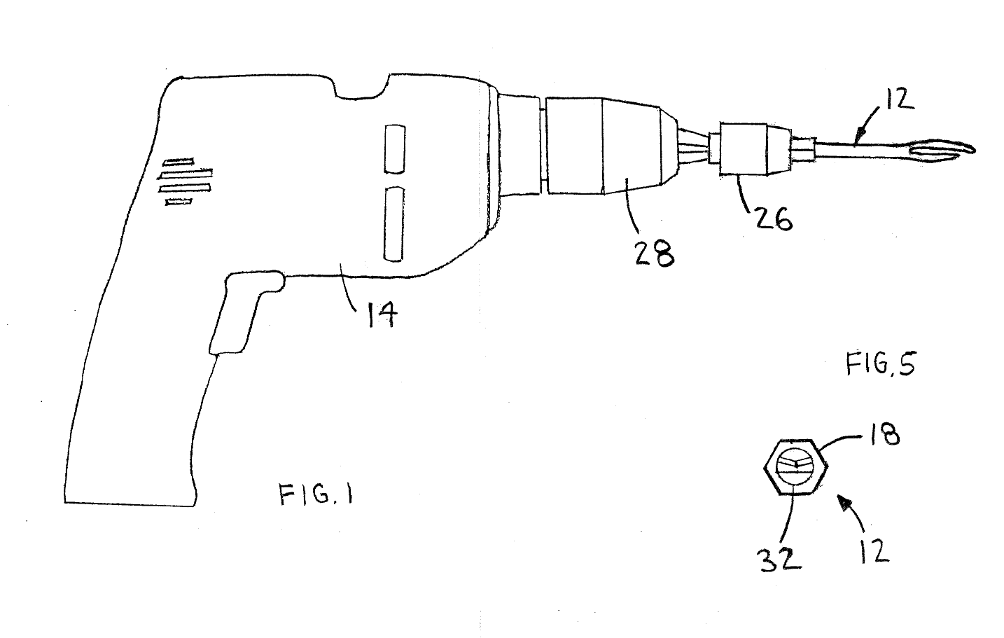

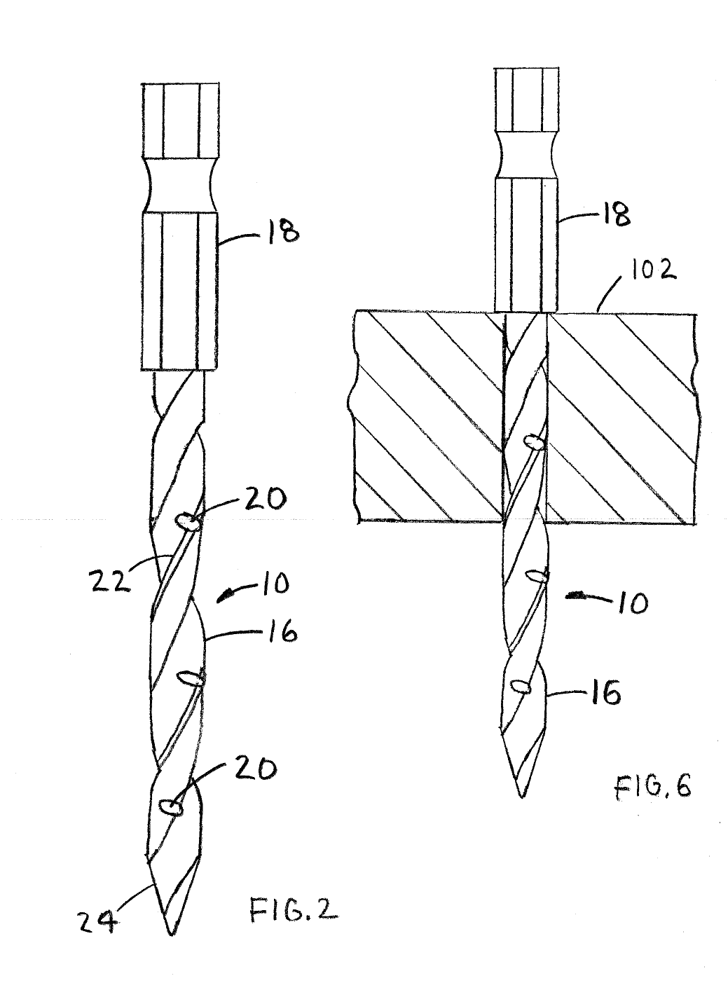

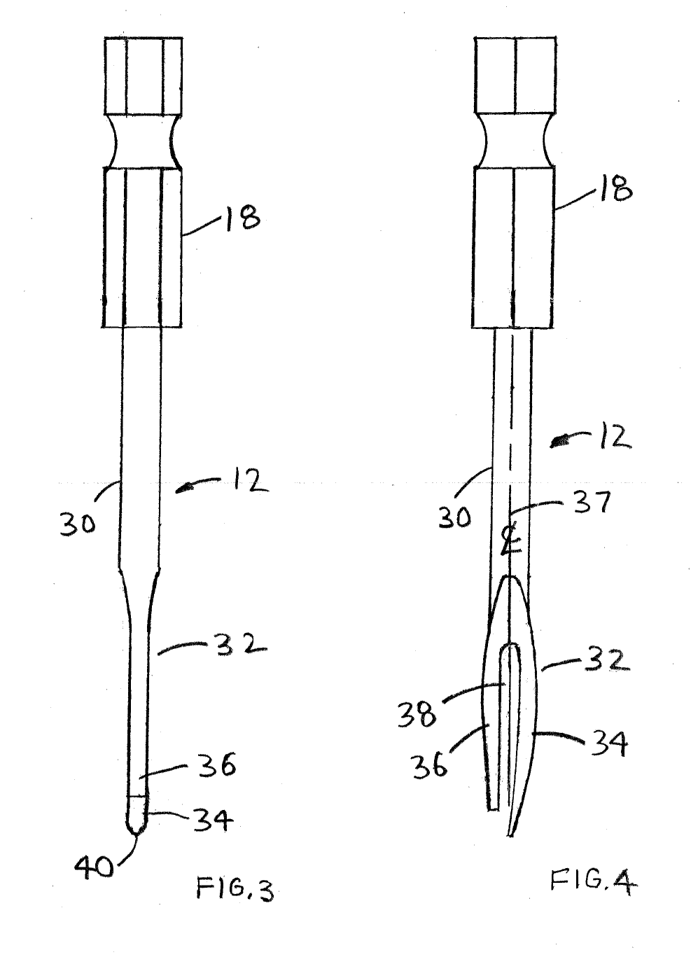

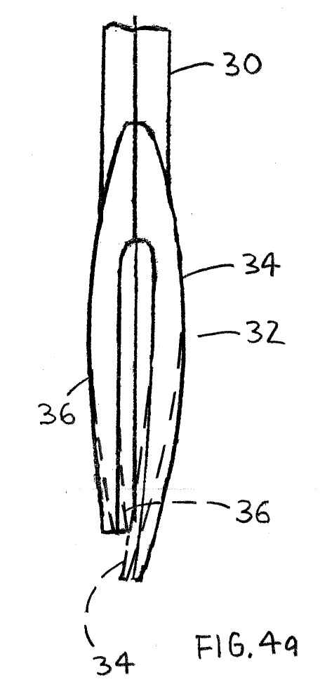

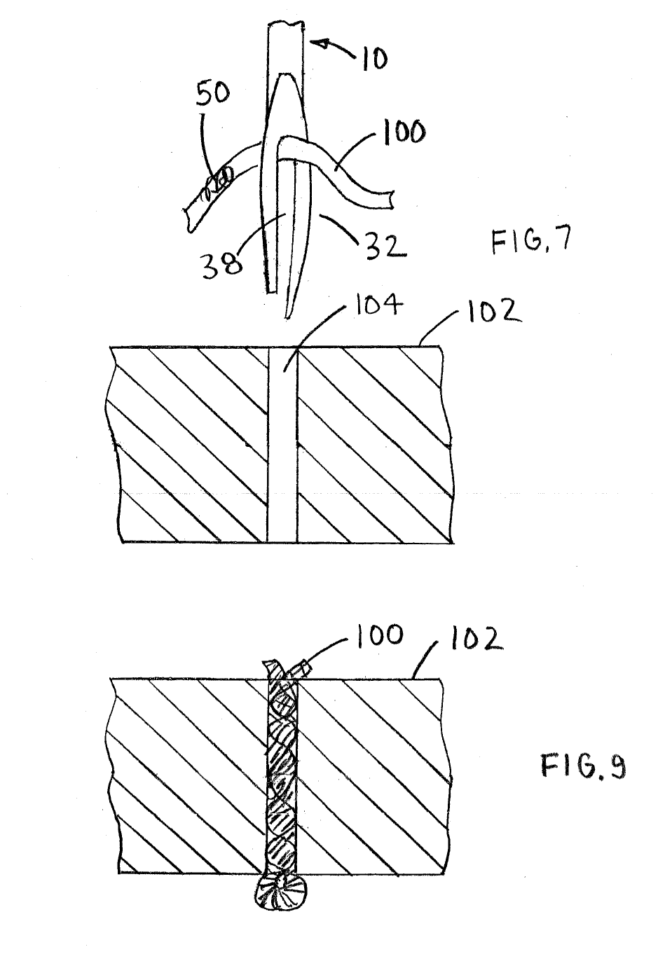

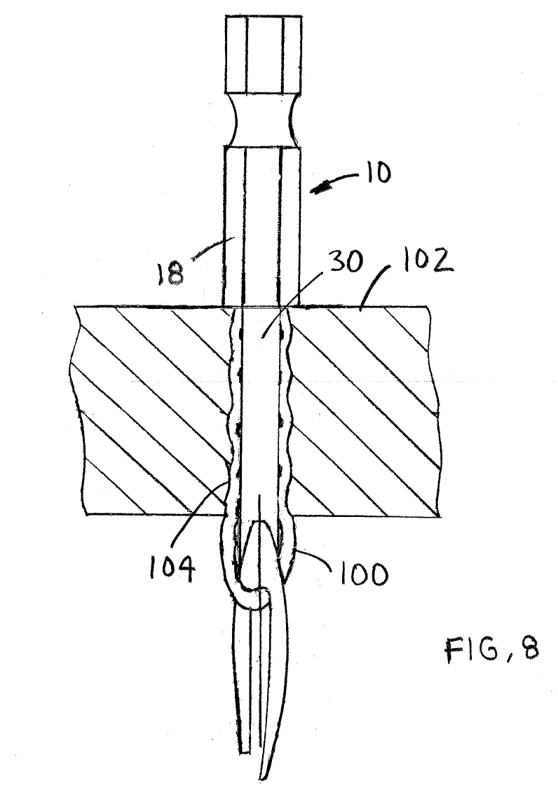

With reference now to the drawings, and particularly to FIG. 1, there is shown a side view of an insertion tool 12 retained in a power tool 14. With reference to FIGS. 2-4, the tire repair tools and method preferably include a rasp tool 10, the insertion tool 12 and the power tool 14. The power tool 14 is a power drill in FIG. 1. The rasp tool 10 preferably includes a modified drill bit 16 and a quick release end 18. A plurality of rasp notches 20 are preferably formed on the flutes 22 of the modified drill bit 16 to simulate the function of a rasp tool. An elongated point 24 is formed on one end of the drill bit 16 and the quick release end 18 is formed on the other end thereof.

With reference to FIG. 6, a perimeter of the modified drill bit 16 is less than a perimeter of the quick release end 18 to act as a stop. The quick release end 18 preferably is sized and shaped to be received by a quick chuck 26 having an internal hex receiver. However, other quick chucks may also be used. The quick release end 18 may also be directly inserted into a chuck 28 of the power tool 14. Quick chucks are well known in the art and need not be explained in detail.

With reference to FIG. 5, the insertion tool 12 preferably includes a shank 30, a plug retention end 32 and the quick release end 18. The plug retention end 32 is formed on one end of the shank 30 and the quick release end 18 is formed on the other end thereof. With reference to FIG. 8, a perimeter of the shank 30 is less than a perimeter of the quick release end 18 to act as a stop.

The plug retention end 32 includes a first projection 34, a second projection 36 and a plug slot 38. The plug slot 38 is disposed between the first projection 36 and the second projection 38. The first projection 36 preferably includes a substantially curved outer surface. An inner surface of the first projection 34 preferably curves toward a centerline 37 of the shank 30. The first projection 34 preferably comes to a point 40. A length of the first projection 34 is preferably longer than a length of the second projection 36. The plug slot 38 is sized to receive a sealing plug 100. A diameter of the shank 30 is greater than a thickness of the first and second projections. With reference to FIG. 4a, it is preferable that the first projection 34 and the second projection 36 flex inward toward each other, when inserted into a tire hole 104 of a tire 102.

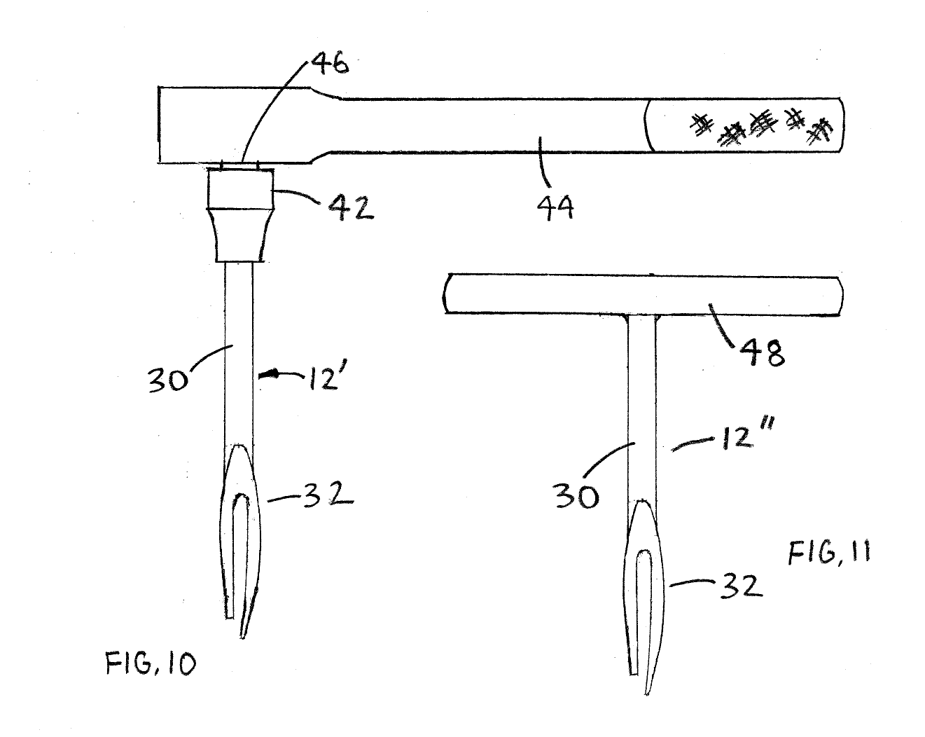

With reference to FIG. 10, a second embodiment of the tire repair tools includes replacing the quick release ends 18 of the rasp tool 10 and the insertion tool 12 with a socket end 42. The socket end 42 is sized to be received by a ratchet projection 46 of a ratchet 44. A second embodiment of the insertion tool 12′ is shown in FIG. 10. With reference to FIG. 11, a third embodiment of the tire repair tools includes replacing the quick release ends 18 of the rasp tool 10 and the insertion tool 12 with a T-handle 48. The T-handle 44 is attached to a shank 30 of the insertion tool 12″ in FIG. 11.

The method of repairing a tire includes inserting the rasp tool 10 into the tire hole 104 of the tire 102 and stroking the rasp tool 10 in the tire hole 104 several times to produce a clean hole, while rotating in the power tool 14. Next, the sealing plug 100 is inserted into the plug slot 38 of the insertion tool 12 and coated with glue 50. The insertion tool 12 is then inserted into the tire hole 104 and the power tool 14 actuated intermittently, until the insertion tool 12 is fully inserted into the tire hole 104. Finally, the insertion tool 12 is then withdrawn from the tire hole 104 without rotating the insertion tool 12. The steps used for repairing a tire in the second and third embodiments are similar to that of the first embodiment. Rotation of the rasp and insertion tools is implemented with the ratchet 44 or the T-handle 48. The power tool 14, the ratchet 44 and the T-handle provide 48 provide leverage for operating the rasp tool 10 and the insertion tool 12.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

I claim:

1. A method of repairing a tire, comprising the step of:
modifying an existing hole in the tire with a first tool;
providing an insertion tool having a shank, forming a plug slot in one end of said shank, said plug slot being sized to retain a sealing plug, said plug slot creating a first projection and a second projection; and
rotating said insertion tool during insertion thereof.

2. The method of repairing a tire of claim 1, further comprising the step of:
providing said first projection with a length that is greater than a length of said second projection.

3. The method of repairing a tire of claim 2, further comprising the step of:
flexing of said first projection toward said second projection during insertion of said insertion tool into a hole in the tire.

4. The method of repairing a tire of claim 1, further comprising the step of:
providing a rasp tool for said first tool, said rasp tool including a drill bit with an elongated point formed on one end.

5. The method of repairing a tire of claim 1, further comprising the step of:
forming a quick release end on the other end of said first tool and said insertion tool.

6. The method of repairing a tire of claim 1, further comprising the step of:
rotating said first tool and said insertion tool with a power tool.

7. The method of repairing a tire of claim 6, further comprising the step of:
inserting at least one of said first tool and said insertion tool into a quick chuck, inserting said quick chuck into a chuck of a power tool.

8. The method of repairing a tire of claim 1, further comprising the step of:
rotating said first tool and said insertion tool with a ratchet.

9. The method of repairing a tire of claim 1, further comprising the step of:
rotating said first tool and said insertion tool with a T-handle.

10. A method of repairing a tire, comprising the step of:
modifying an existing hole in the tire with a first tool, rotating said first tool to modify the existing hole;
providing an insertion tool having a shank, forming a plug slot in one end of said shank, said plug slot being sized to retain a sealing plug, said plug slot creating a first projection and a second projection; and
rotating said insertion tool during insertion thereof.

11. The method of repairing a tire of claim 10, further comprising the step of:
providing said first projection with a length that is greater than a length of said second projection.

12. The method of repairing a tire of claim 11, further comprising the step of:
flexing of said first projection toward said second projection during insertion of said insertion tool into a hole in the tire.

13. The method of repairing a tire of claim 10, further comprising the step of:
providing a rasp tool for said first tool, said rasp tool including a drill bit with an elongated point formed on one end.

14. The method of repairing a tire of claim 10, further comprising the step of:
forming a quick release end on the other end of said first tool and said insertion tool.

15. The method of repairing a tire of claim 10, further comprising the step of:
rotating said first tool and said insertion tool with a power tool.

16. The method of repairing a tire of claim 15, further comprising the step of:
inserting at least one of said first tool and said insertion into a quick chuck, inserting said quick chuck into a chuck of a power tool.

17. The method of repairing a tire of claim 10, further comprising the step of:
rotating said first tool and said insertion tool with a ratchet.

18. The method of repairing a tire of claim 10, further comprising the step of:
rotating said first tool and said insertion tool with a T-handle.

19. A method of repairing a tire, comprising the step of:
modifying an existing hole in the tire with a rasp tool, said rasp tool including a drill bit with an elongated point, rotating said rasp tool to modify the existing hole;
providing an insertion tool having a shank, forming a plug slot in one end of said shank, said plug slot being sized to retain a sealing plug, said plug slot creating a first projection and a second projection; and
rotating said insertion tool during insertion thereof.

20. The method of repairing a tire of claim 19, further comprising the step of:
flexing of said first projection toward said second projection during insertion of said insertion tool into a hole in the tire.
